(19) United States
(12) Patent Application Publication
(10) Pub. No.: US 2014/0267782 A1
(43) Pub. Date: Sep. 18, 2014

(54) Apparatus And Method For Automated Self-Training Of White Balance By Electronic Cameras

(71) Applicant: OmniVision Technologies, Inc., Santa Clara, CA (US)

(72) Inventor: Changmeng Liu, San Jose, CA (US)

(73) Assignee: OmniVision Technologies, Inc., Santa Clara, CA (US)

(21) Appl. No.: 14/210,337

(22) Filed: Mar. 13, 2014

Related U.S. Application Data
(60) Provisional application No. 61/780,898, filed on Mar. 13, 2013.

(51) Int. Cl. H04N 1/60

(52) U.S. Cl. CPC H04N 1/6077
USPC 348/187

(57) ABSTRACT

A method for calibrating auto white balancing in an electronic camera includes (a) obtaining a plurality of color values from a respective plurality of images of real-life scenes captured by the electronic camera under a first illuminant, (b) invoking an assumption about a true color value of at least portions of the real-life scenes, and (c) determining, based upon the difference between the true color value and the average of the color values, a plurality of final auto white balance parameters for a respective plurality of illuminants including the first illuminant. An electronic camera device includes an image sensor for capturing real-life images of real-life scenes, instructions including a partly calibrated auto white balance parameter set and auto white balance self-training instructions, and a processor for processing the real-life images according to the self-training instructions to produce a fully calibrated auto white balance parameter set specific to the electronic camera.

### RELATED APPLICATIONS

This application claims priority to U.S. Patent Application Ser. No. 61/780,898, filed Mar. 13, 2013, the disclosure of which is incorporated herein by reference.

### BACKGROUND

White balance is the process of removing unrealistic color casts from images captured by an electronic camera, such that the images provide a true color representation of a scene. For example, objects in the scene that appear white to human eyes are rendered white by white balancing the initial output of an image sensor. Human eyes are very good at judging what is white under different light sources, but image sensors often have great difficulty doing so, and often create unsightly blue, orange or green color casts. Different illuminants, i.e., light sources, have their unique spectral characteristics. The spectral characteristics of a given illuminant may be represented by its color temperatures. The color temperature of a light source is the temperature of an ideal black body radiator that radiates light of comparable hue to the light source. The color temperature refers to the relative warmth or coolness of white light. As the color temperature rises, the light energy increases. Hence, the wavelengths of light emitted by the illuminant become shorter, i.e., shift towards the blue portion of the visible spectrum, and the color hue becomes cooler.

An image sensor capturing images of a scene illuminated by a given illuminant will initially produce images with colors affected by the color temperature of the illuminant. Therefore, many electronic cameras use automatic white balance (AWB) to correct for the color output of the image sensor according to the illuminant. In order to apply AWB, the electronic camera must have AWB parameters, often represented as gains to color channels, for each illuminant. The AWB unit of an electronic camera first determines which illuminant is being used to illuminate the scene. Next, the AWB unit applies the AWB parameters of that illuminant to the image of the scene to provide an image with a more true representation of the colors of the scene.

Typically, to produce a set of AWB parameters for an electronic camera, the electronic camera captures images of a gray object, such as a specially made gray card, under various color temperature illumination conditions representing the range of illuminants encountered in actual use. For example, images are captured under four different reference illuminants: a D65 light source which corresponds to noon daylight and has a color temperature of 6504 degrees, a cool white fluorescent (CWF) lamp with a color temperature of 4230 degrees K, a TL84 fluorescent lamp with a color temperature of 4000 K, and light source A (incandescent tungsten) with a color temperature of 2856 K. Ideally, a manufacturer of electronic cameras with an AWB function, should perform this calibration procedure for each electronic camera produced. However, such a practice is generally too expensive. A common practice in the image sensor industry is to calibrate one or a small number of electronic cameras, called the golden modules, under various illumination conditions, and then apply the resulting AWB parameter set to all other image sensors. However, sensor-by-sensor variation inherently exists due to variation in the spectral properties of, e.g., the spectral properties of the quantum efficiency, the color filter array, and the infrared-cut filter of the image sensor. As a result, using the golden module AWB parameter set for all other image sensors frequently leads to errors.

### SUMMARY

In an embodiment, a method for calibrating auto white balancing in an electronic camera includes (a) obtaining a plurality of first color values from a respective first plurality of images, of a respective plurality of real-life scenes, captured by the electronic camera under a first illuminant, (b) invoking an assumption about a true color value of at least portions of the real-life scenes, and (c) determining, based upon the difference between the true color value and the average of the first color values, a plurality of final auto white balance parameters for a respective plurality of illuminants including the first illuminant.

In an embodiment, an electronic camera device includes (a) an image sensor for capturing real-life images of real-life scenes, (b) a non-volatile memory with machine-readable instructions, the instructions including a partly calibrated auto white balance parameter set and auto white balance self-training instructions, and (c) a processor for processing the real-life images according to the self-training instructions to produce a fully calibrated auto white balance parameter set, wherein the fully calibrated auto white balance parameter set is specific to the electronic camera.

### BRIEF DESCRIPTION OF THE DRAWINGS

FIG. 1 illustrates one exemplary scenario 100 for automated self-training of an electronic camera that includes a self-training module, according to an embodiment.

FIG. 2 is a diagram illustrating exemplary AWB parameters, for a plurality of exemplary illuminants, according to an embodiment.

FIG. 3 illustrates one exemplary electronic camera that includes a module for automated self-training of AWB parameters, according to an embodiment.

FIG. 4 illustrates one exemplary memory of an electronic camera that includes a module for automated self-training of AWB parameters, according to an embodiment.

FIG. 5 illustrates one exemplary method for calibrating an AWB parameter set for an electronic camera, utilizing, in part, automated self-training by the electronic camera through imaging of real-life scenes, according to an embodiment.

FIG. 6 is a diagram illustrating one exemplary transformation performed in the method of FIG. 5 for an exemplary plurality of illuminants, wherein a base AWB parameter set is transformed to an initial AWB parameter set, according to an embodiment.

FIG. 7 is a diagram illustrating one exemplary transformation performed in the method of FIG. 5 for an exemplary plurality of illuminants, wherein an initial AWB parameter set is transformed to a final AWB parameter set, according to an embodiment.

FIG. 8 illustrates one exemplary method for calibrating an AWB parameter for a reference illuminant through imaging of a gray card, according to an embodiment.

FIG. 9 illustrates one exemplary method for performing the automated self-training portion of the method of FIG. 5, using a gray world assumption, according to an embodiment.

FIG. 10 is a diagram illustrating one exemplary method for identifying one exemplary illuminant, according to an embodiment.

FIG. 11 illustrates one exemplary method for performing the automated self-training portion of the method of FIG. 5, using a universal human facial hue assumption, according to an embodiment.

FIG. 12 illustrates one exemplary method for calibrating an AWB parameter for a reference illuminant through imaging of a sample set of human faces, according to an embodiment.

### DETAILED DESCRIPTION OF THE EMBODIMENTS

Disclosed herein are devices and methods for calibrating AWB parameters of an electronic camera that partly relies on automated self-training of the camera during initial use by an actual user. The automated self-training completes the AWB calibration procedure to provide a fully calibrated AWB function while relieving the manufacturer of cost-prohibitive calibration expenses. The AWB calibration procedure includes at least three main steps. First, a golden module electronic camera is used to generate a base AWB parameter set that covers illuminants having a range of color temperatures. The base AWB parameter set is applied to all the electronic cameras associated with the golden module electronic camera, for example all cameras of the same model or all cameras from the same production run. Next, the AWB parameter for a single reference illuminant, such as the D65 illuminant, is calibrated for each individual electronic camera. After this step, the camera is shipped to a user. Finally, a second AWB parameter for another illuminant is calibrated through automated self-training of the electronic camera during normal use by the user. After calibration of the second AWB parameter through automated self-training, the full set of AWB parameters is transformed according to the two calibrated AWB parameters.

FIG. 1 illustrates one exemplary scenario 100 for automated self-training of an electronic camera 110. The electronic camera includes a self-training module 120 and an AWB parameter set 130. A user captures a plurality of images of real-life scenes 150. Self-training module 120 analyzes the images of real-life scenes 150 to update AWB parameter set 130 from an initial AWB parameter set, provided with the electronic camera, to a final AWB parameter set to be used for auto white balancing of images captured after automated self-training. In an embodiment, the initial AWB parameter set is the base AWB parameter set obtained from the calibration of an associated golden module electronic camera. In another embodiment, the initial AWB parameter set is an AWB parameter set obtained by adjusting the base AWB parameter set, obtained from the calibration of an associated golden module electronic camera, according to a partial calibration of electronic camera 110 by the manufacturer.

FIG. 2 is a diagram 200 illustrating exemplary AWB parameters, for a plurality of exemplary illuminants. Diagram 200 includes AWB parameters 220, 222, 224, and 226 for respective illuminants D65, TL84, CWF, and A. In an embodiment, AWB parameters 220, 222, 224, and 226 are base AWB parameters obtained from the calibration of a golden module electronic camera by capturing images under the illuminants D65, TL84, CWF, and A. Diagram 200 places AWB parameters 220, 222, 224, and 226 in a two-dimensional space spanned by horizontal axis 210 and vertical axis 212. It is assumed that color is defined by the relative strengths of three primary color components outputted by an image sensor, such as red (R), green (G), and blue (B) as is done with the RGB image sensors most commonly used in electronic cameras. Each of horizontal axis 210 and vertical axis 212 represents a color ratio. A point in the space spanned by horizontal axis 210 and vertical axis 212 represents an ordered pair [x, y] of color ratios. The ordered pair of color ratios defines a color composition. Examples of ordered pairs of color ratios include [G/B, G/R], [R*B/G2, B/R], [log(G/B), log(G/R)], [log(R*B/G2), log(B/R)], and derivatives thereof. In the following, it is assumed that the ordered pair of color ratios is [G/B, G/R]. Other ordered pairs of color ratios, such as those mentioned above, as well as other sets of primary colors may be used without departing from the scope hereof.

As is evident by the dispersion of AWB parameters 220, 222, 224, and 226 in diagram 200, the respective illuminants D65, TL84, CWF, and A have different color compositions. For example, illuminant D65 (label 220) is shifted towards the blue end of the visible spectrum, while illuminant A (label 226) is shifted towards the red and green portions of visible spectrum. Illuminants TL84, CWF, and A are redder and less blue than illuminant D65. This illustrates the importance of proper white balancing of images captured by an electronic camera according to the illuminant illuminating the scene. For example, an image captured under illuminant A may appear to have a red color cast if the image is not white balanced. White balancing of an image captured under illuminant A is achieved by correcting the colors of the image according to the ordered pair of color ratios associated with illuminant A in diagram 200. Under the stated assumption that the ordered pair is [G/B, G/R], blue and red color components of the image are multiplied by the respective color ratios of horizontal axis 210 and vertical axis 212. By characterizing the illuminants according to the color ratios G/B and G/R, diagram 200, or any equivalent graphical or non-graphical representation thereof, conveniently provides the color gains to be used to white balance the image. Other examples of ordered pairs, such as [R*B/G2, B/R] will provide the same color gains after a simple algebraic manipulation.

FIG. 3 illustrates one exemplary electronic camera 300. Electronic camera 300 is an embodiment of electronic camera 110 of FIG. 1 and includes self-training module 120 of FIG. 1. Electronic camera 300 includes an image sensor 310 for capturing images formed thereupon by an objective 320. Electronic camera 300 further includes a processor 330, a memory 340, and an interface 380. Processor 330 is communicatively coupled to image sensor 310, memory 340, and interface 380. Memory 340 includes AWB parameter set 130 of FIG. 1, machine-readable instructions 350 and data storage 360. Memory 340 may include both volatile and non-volatile memory. In certain embodiments, instructions 350 and AWB parameter set 130 are stored in a non-volatile portion of memory 340, while portions of data storage 360 is located in volatile memory. Processor 330 processes images captured by image sensor 310 according to instructions 350. Electronic camera 300 further includes an optional power supply 385 and an enclosure 390 for respectively powering and environmental protection of components of electronic camera 300. During automated self-training of auto white balance of electronic camera 300, images captured by image sensor 310 are processed by processor 350, according to self-training instructions included in instructions 350, to update AWB parameter set 130 from an initially provided AWB parameter set to a final AWB parameter set.

For example, processor 330 analyzes the captured images according to instructions 350 and, based thereupon, saves images deemed suitable for AWB self-training to data storage 360. When a sufficient number of images suitable for AWB self-training have been stored to data storage 360, processor 330 analyzes the stored images according to instructions 350 to determine the final AWB parameter set. Temporary values and results generated by processor 330 during this process may be stored to data storage 360 or kept in a working memory not shown in FIG. 3. Processor 330 then stores the final AWB parameter set as AWB parameter set 130.

Processor 330, instructions 350, and data storage 360 together constitute and embodiment of self-training module 120 of FIG. 1. All of processor 330, instructions 350, and data storage 360 may perform other functions not related to AWB self-training. Processor 330 may auto white balance images captured after completion of self-training, according to instructions 350. In one example of use, all images captured during AWB self-training are stored to data storage 360. After completion of AWB self-training, all stored images may be auto white balanced by processor 330 according to instructions 350 and using the final AWB parameter set 130. Thereby, properly auto white balanced versions of images captured during AWB self-training may be made available to the user of electronic camera 300.

Images captured by image sensor 310 and, optionally, white balanced by processor 330 may be outputted to a user through interface 380. Interface 380 may include, e.g., a display and a wired or wireless communication port. Interface 380 may further be used to received instructions and other data from an outside source such as a user.

FIG. 4 illustrates one exemplary memory 400 that is an embodiment of memory 340 of electronic camera 300 (FIG. 3). Memory 400 includes AWB parameter set 130 (FIGS. 1 and 3), instructions 450, and data storage 460. Instructions 450 is an embodiment of instructions 350 (FIG. 3). Instructions 450 include a number of elements, the role of some of which will be discussed later in this disclosure. Instructions 450 includes color value extraction instructions 451 for extracting color information from images, for example expressed as the strength of primary colors as discussed in connection with FIG. 2. Instructions 450 includes color ratio calculation instructions 452 for calculating color ratios, such as those discussed in connection with FIG. 2, based upon the color values determined using color value extraction instructions 451. Instructions 450 includes color ratio to AWB parameter calculation instructions 453 for deriving AWB parameters from color ratios determined using color ratio calculation instructions 452, as discussed in connection with FIG. 2. Instructions 450 further includes illuminant identification instructions 454 for identifying the illuminant under which an image is captured by, e.g., image sensor 310 of electronic camera 300 (FIG. 3); face detection instructions 455 for detecting faces in such images; and AWB parameter transformation instructions 456 for transforming a base AWB parameter set resulting from a golden module calibration or a partially calibrated, initially provided AWB parameter set into a final AWB parameter set. A processor, e.g., processor 330 of (FIG. 3), executes instructions 451 through 456. Memory 450 further includes assumptions 480 utilized in automated AWB self-training based on images of real-life scenes. Assumptions 480 may include gray world assumption instructions 481 and/or universal human facial hue assumption instructions 482.

Data storage 460 is an embodiment of data storage 360 (FIG. 3). Data storage 460 includes image storage 461, color value storage 462, and color ratio storage 463. A processor, such as processor 330 of FIG. 3, may access all of these storage elements. Image storage 461 stores images captured by an image sensor, for example image sensor 310 of FIG. 3. Color value storage 462 stores color values generated by, e.g., processor 330 of FIG. 3, according to color value extraction instructions 451. Color ratio storage 463 is used for storing color ratios generated by, e.g., processor 330 of FIG. 3, according to color ratio calculation instructions 452.

In certain embodiments, data storage 460 further includes an initial AWB parameter set 464, which is a partially calibrated AWB parameter set that is either provided with the electronic camera, e.g., electronic camera 300 (FIG. 3) by the manufacturer thereof or derived from information provided with the electronic camera by its manufacturer. In such embodiments, AWB parameter set 130 is the base AWB parameter set obtained through a calibration of an associated golden module electronic camera. Initial AWB parameter set 464 may be generated, for example, by processor 330 (FIG. 3), based upon base AWB parameter set 130 and manufacturer-provided information stored in memory 400, according to AWB parameter transformation instructions 456. In other embodiments, the electronic camera, e.g., electronic camera 300 (FIG. 3) with memory 400 is provided, by the manufacturer, with AWB parameter set 130 being the initial AWB parameter set resulting from a partial calibration of the electronic camera. In this case, initial AWB parameter set 464 is not needed.

FIG. 5 illustrates one exemplary method 500 for calibrating an AWB parameter set for an electronic camera, utilizing automated self-training by the electronic camera through imaging of real-life scenes. The automated self-training may be performed during normal use of the electronic camera, by a user, and completes a partial calibration performed by the camera manufacturer. Method 500 is implemented in, for example, electronic camera 110 of FIG. 1 or electronic camera 300 of FIG. 3.

In a step 510, a base AWB parameter set is obtained from the calibration of an associated golden module electronic camera under several illuminants. Diagram 200 of FIG. 2 illustrates one exemplary base AWB parameter set with four AWB parameters 220, 222, 224, and 226 for four respective illuminants D65, TL84, CWF, and A. In an example, the manufacturer of electronic camera 300 (FIG. 3) stores the base AWB parameter set to electronic camera 300 as AWB parameter set 130 (FIGS. 1 and 3). Processor 330 of electronic camera 300 may then retrieve, as needed, AWB parameter set 130 from memory 340.

In a step 520, the electronic camera captures images under a reference illuminant, where the reference illuminant is one of the illuminants used to produce the base AWB parameter set obtained in step 510. For example, prior to shipping electronic camera 300 (FIG. 3) to a user, the manufacturer thereof captures a plurality of images under the D65 illuminant, using electronic camera 300. In a step 530, the images captured in step 520 are analyzed to determine an AWB parameter for the reference illuminant, where the AWB parameter is calibrated specifically for the electronic camera, e.g., electronic camera 300 (FIG. 3).

In a step 540, the base AWB parameter set obtained in step 510 is transformed into an initial AWB parameter set, such that the initial AWB parameter for the reference illuminant is that obtained in step 530. In an embodiment, step 540 is performed by the manufacturer and the resulting initial AWB parameter set is stored to the electronic camera, e.g., electronic camera 300 (FIG. 3), as, e.g., AWB parameter set 130 (FIGS. 1 and 3). In another embodiment, the initial AWB parameter for the reference illuminant generated in step 530 is stored to the electronic camera, e.g., to memory 340 (FIG. 3) of camera 300 (FIG. 3). In this embodiment, the base AWB parameter set obtained in step 510 is also stored to the electronic camera, for example to AWB parameter set 130 (FIGS. 1 and 3) of electronic camera 300 (FIG. 3). The transformation of the base AWB parameter set to the initial AWB parameter set is then performed onboard the electronic camera. For example, processor 330 (FIG. 3) of electronic camera 300 (FIG. 3), with memory 400 (FIG. 4) implemented as memory 340 (FIG. 3), performs the transformation of AWB parameter set 130 according to AWB parameter transformation instructions 456. Processor 330 (FIG. 3) then stores the resulting AWB parameter set to memory 400 (FIG. 4) as initial parameter set 464 (FIG. 4).

In a step 550, images of real-life scenes are captured using the electronic camera. Step 550 is, for example, performed by a user who captures images of real-life scenes using electronic camera 300 (FIG. 3) with memory 400 (FIG. 4) being implemented as memory 340 (FIG. 3). Processor 330 (FIG. 3) receives the real-life images from image sensor 310 (FIG. 3) and either stores the real-life images to image storage 461 (FIG. 4) or keep them in working memory for further processing in a subsequent step 555. In step 555, the electronic camera analyzes the real-life images captured in step 550. Real-life images captured under a given, first illuminant are used to calibrate an AWB parameter for the first illuminant. The first illuminant is one of the illuminants used to generate the base AWB parameter set obtained in step 510 or an illuminant substantially similar thereto. The first illuminant is different from the reference illuminant used in step 530. Step 555 is for example executed by processor 330 (FIG. 3) of electronic camera 300 (FIG. 3) with memory 400 (FIG. 4) implemented as memory 340 (FIG. 3). Processor 330 (FIG. 3) analyzes images received from image sensor 310 (FIG. 3) or retrieved from image storage 461 (FIG. 4). Processor 330 (FIG. 3) then analyzes the real-life images according to illuminant identification instructions 454 (FIG. 4) and selects real-life images captured under, e.g., illuminant A, for further processing according to instructions 450 (FIG. 4) to determine a calibrated AWB parameter for illuminant A. Steps 550 and 555 may be performed in parallel or series with step 540.

In a step 560, the initial AWB parameter set generated in step 540 is further transformed according to the calibration, generated in step 555, of the AWB parameter for the first illuminant. This produces a final AWB parameter set calibrated specifically to this particular electronic camera. The final AWB parameter set includes the calibrated AWB parameters for the reference and first illuminants, generated in steps 540 and 555, respectively. Step 560 is, for example, executed by processor 330 (FIG. 3) of electronic camera 300 (FIG. 3) with memory 400 (FIG. 4) implemented as memory 340 (FIG. 3). Processor 330 (FIG. 3) retrieves the initial AWB parameter set from either AWB parameter set 130 (FIGS. 1 and 3) or initial AWB parameter set 464. Processor 330 (FIG. 3) then transforms the initial AWB parameter set according to AWB parameter transformation instructions 456 (FIG. 4).

Steps 550, 555, and 560 constitute the automated self-training portion of the calibration of AWB parameters for the electronic camera.

FIG. 6 is a diagram 600 illustrating one exemplary transformation performed in step 540 of method 500 (FIG. 5) for an exemplary plurality of illuminants. Diagram 600 illustrates the transformation of the base AWB parameter obtained in step 510 (FIG. 5) to form the initial AWB parameter set in step 540 (FIG. 5), where the transformation is performed in a color-ratio parameter space as discussed in connection with FIG. 2. Diagram 600 relates to diagram 200 of FIG. 2 with diagram 200 illustrating the base AWB parameter set. Step 530 (FIG. 5) provides an AWB parameter for the reference illuminant calibrated specifically for the electronic camera in question. In diagram 600, the reference illuminant is assumed to be the D65 illuminant. In step 540 (FIG. 5), the base AWB parameter set is translated to shift the position of the base AWB parameter for illuminant D65 (label 220) to the position of the specifically calibrated AWB parameter for illuminant D65 (label 620) obtained in step 530 (FIG. 5). This results in an initial AWB parameter set consisting of specifically calibrated AWB parameter 620 for the D65 illuminant and translated AWB parameters 622, 624, and 626 for respective illuminants TL84, CWF, and A.

FIG. 7 is a diagram 700 illustrating one exemplary transformation performed in step 560 of method 500 (FIG. 5) for an exemplary plurality of illuminants. Diagram 700 relates to diagram 600 (FIG. 6), with AWB parameters 620, 622, 624, and 626 of FIG. 6 constituting the initial AWB parameter set. Step 560 (FIG. 5) transforms the initial AWB parameter to a final AWB parameter set that includes specifically calibrated AWB parameter 620 and a specifically calibrated AWB parameter 726 for illuminant A generated in step 555 (FIG. 5). The remaining AWB parameters, not specifically calibrated using the electronic camera in question, are transformed accordingly. In the non-limiting example illustrated in diagram 600, the initial AWB parameter set is transformed by a rotation 730 followed by a scaling 740. Rotation 730 rotates the initial AWB parameter set about a rotation axis coinciding with specifically calibrated AWB parameter 620. Scaling 740 scales the rotated parameter set along line 770, such that AWB parameter 620 is unaffected by the scaling and initial AWB parameter 626 ends up at the position of specifically calibrated AWB parameter 726. Accordingly, initial AWB parameters 622 and 624 are rotated and scaled to yield final AWB parameters 722 and 724. The result is a final AWB parameter set consisting of final AWB parameters 620, 722, 724, and 726 for respective illuminants D65, TL84, CWF, and A.

In certain embodiments, the transformations performed in steps 540 and 560 of method 500 (FIG. 5), as illustrated in the examples of diagrams 600 (FIG. 6) and 700 (FIG. 7), are performed by applying a matrix operation to an AWB parameter set in a two-dimensional color-ratio space. Steps 540 and 560 of method 500 (FIG. 5) may be performed separately using two separate matrix operations, where one matrix contains the transformation of step 540 (FIG. 5) and another matrix contains the transformation of step 560 (FIG. 5). Alternatively, the transformations of steps 540 and 560 of method 500 (FIG. 5) are performed in a single matrix operation, where the matrix applied is the product of the two separate matrices associated with the transformations of steps 540 (FIG. 5) and 560 (FIG. 5).

In an embodiment, the initial AWB parameter set generated in step 540 is further translated to place the AWB parameter for the reference illuminant at the origin of the coordinate system in which the transformation is performed. Referring to the example of diagram 600 (FIG. 6), AWB parameters 620, 622, 624, and 626 are translated such that AWB parameter 620 is at the origin. This simplifies the subsequent manipulations of the initial AWB parameter set performed in step 560 (FIG. 5).

The full AWB calibration procedure, for the electronic camera is as a camera-specific transformation of the base AWB parameter set. The specific calibration of an AWB parameter for a reference illuminant (step 530 of FIG. 5) provides a first anchor point, and the specific calibration of another AWB parameter (step 555 of FIG. 5), obtained through automated self-training, provides a second anchor point. In certain embodiments, the two illuminants used in the specific calibration of AWB parameters are at opposite extremes of the color temperature range. This may provide improved accuracy of the final AWB parameter set.

FIG. 8 illustrates one exemplary method 800 for performing steps 520 and 530 of method 500 (FIG. 5). In a step 810, which is an embodiment of step 520 (FIG. 5), images are captured by the electronic camera of a gray card illuminated by a reference illuminant. For example, electronic camera 300 of FIG. 3 captures images of a gray card illuminated by the D65 illuminant. In a step 820, the color of each image of the gray card is determined. In one embodiment, functionality onboard the electronic camera performs step 820. For example, processor 330 of electronic camera 300 (FIG. 3), with memory 400 (FIG. 4) implemented as memory 340 (FIG. 3), processes the captured images according to color value extraction instructions 451 (FIG. 4). In another embodiment, step 820 is performed using functionality outside the electronic camera, e.g., electronic camera 300 (FIG. 3), for example equipment at the manufacturing facility. Step 820 may be performed prior to full assembly of the electronic camera. In a step 830, the colors obtained in step 820 are averaged to determine an average color for the images of the gray card illuminated by the reference illuminant. Step 830 may be performed externally to the electronic camera, e.g., electronic camera 300 (FIG. 3). Alternatively, step 830 may be performed onboard the electronic camera, for example by processor 330 of electronic camera 300 (FIG. 3) according to instructions 350 (FIG. 3).

The average color obtained in step 830 may be different from the actual color of the gray card. For example, the average color may be shifted towards red or blue. In a step 840, the AWB parameter for the reference illuminant is calibrated such that the calibrated AWB parameter, when applied to the average color determined in step 830, yields the color gray, i.e., the actual color of the gray card. In one embodiment, step 840 is performed onboard the electronic camera. For example, processor 330 of electronic camera 300 (FIG. 3) performs step 840 is according to instructions 350 (FIG. 3). In another embodiment, step 840 is performed externally to the electronic camera.

Method 800 describes processing of images in steps 810, 820, and 830 with all images processed by step 810, followed by all images processed by step 820, followed by all images processed by step 830. Images may instead be sequentially processed by two subsequent steps of steps 810, 820, and 830, or all of steps 810, 820, and 830, without departing from the scope hereof.

FIG. 9 illustrates one exemplary method 900 for performing step 555 of method 500 (FIG. 5). Method 900 is part of the automated self-training based on real-life images and utilizes the so-called gray world assumption. The gray world assumption states that, given an image with sufficient amount of color variations, the average value of its primary color components, e.g., R, G and B components, should average out to a common gray value. Generally, this assumption is a reasonable approximation since any given real-life scene usually has a lot of color variation. Nevertheless, single real-life scenes may have a color composition that does not average out to a gray value, for example a scene composed primarily of blue sky. However, during normal use of an electronic camera, the camera will probably capture images of a great variety of real-life scenes such that the average color of a plurality of captured images is indeed gray.

In a step 910, a color value is determined for each real-life image captured by the electronic camera. In an embodiment, the color value of a real-life image is the average color of the image. Step 910 is, for example, performed by processor 330 of electronic camera 300 (FIG. 3) with memory 400 (FIG. 4) implemented as memory 340 (FIG. 3). Processor 330 (FIG. 3) either receives images from image sensor 310 (FIG. 3) or retrieves images from image storage 461 (FIG. 4), and processes the images according to color value extraction instructions 451 (FIG. 4). In a step 920, the color values obtained in step 910 are evaluated to identify real-life images captured under the first illuminant. In an embodiment, real-life images, with an associated color value within a specified range of the color value of a gray card illuminated by the first illuminant, are identified as being captured under the first illuminant. Step 920 is, for example, performed by processor 330 of electronic camera 300 (FIG. 3) with memory 400 (FIG. 4) implemented as memory 340 (FIG. 3). Processor 330 (FIG. 3) retrieves color values from color value storage 462 (FIG. 4) and processes the color values according to illuminant identification instructions 454 (FIG. 4) to identify real-life images captured under, e.g., illuminant A. Processor 330 (FIG. 3) then saves the real-life images captured under the first illuminant or a record thereof to image storage 461 (FIG. 4), and/or saves the color values associated therewith to color value storage 462 (FIG. 4).

FIG. 10 is a diagram 1000 illustrating step 920 of method 900 (FIG. 9) for one exemplary first illuminant, illuminant A of diagram 200 (FIG. 2). Diagram 1000 is identical to diagram 200 of FIG. 2, except for further illustrating a range 1010 of color values near AWB parameter 226 that are interpreted as originating from real-life images captured under illuminant A.

Returning to FIG. 9, in a step 930, the average color value for real-life images captured under the first illuminant is determined, where the real-life images contributing to the average are those identified in step 920. Step 920 is, for example, performed by processor 330 of electronic camera 300 (FIG. 3) with memory 400 (FIG. 4) implemented as memory 340 (FIG. 3). Processor 330 (FIG. 3) retrieves the appropriate color values from color value storage 462 (FIG. 4) and calculates the average color value according to instructions in color value extraction instructions 451 (FIG. 4).

A step 940 invokes the gray world assumption discussed above. For example, processor 330 of electronic camera 300 (FIG. 3) with memory 400 (FIG. 4) implemented as memory 340 (FIG. 3) invokes the gray world assumption. Processor 330 (FIG. 3) retrieves gray world assumption instructions 481 from memory 450. In a step 950, the camera-specific calibrated AWB parameter for the first illuminant is determined using the gray world assumption invoked in step 940. In accordance with the gray world assumption, the camera-specific calibrated AWB parameter for the first illuminant is determined such that the AWB parameters, when applied to the real-life images captured under the first illuminant, yield an average color of the real-life images that is gray. In certain embodiments, the average color value, obtained in step 930, is expressed in terms of color ratios. For example, the average color ratio is expressed as an ordered pair of color ratios, which defines the relative strength of three primary color components, as discussed in connection with FIG. 2. Next, the camera-specific calibrated AWB parameter may be calculated from the ordered pair of color ratios. Step 950 is, for example, performed by processor 330 of electronic camera 300 (FIG. 3) with memory 400 (FIG. 4) implemented as memory 340 (FIG. 3). Processor 330 (FIG. 3) retrieves color values from color value storage 462 (FIG. 4), derives color ratios according to instructions in color ratio calculation instructions 452 (FIG. 4), and stores the color ratios to color ratio storage 463 (FIG. 4). Next, processor 330 (FIG. 3) processes the color ratios stored in color ratio storage 463 (FIG. 4), according to color ratio to AWB parameter calculation instructions 453 (FIG. 4), to produce the camera-specific calibrated AWB parameter for the first illuminant.

Method 900 describes processing of images in steps 910 and 920 with all images processed by step 910, followed by all images processed by step 920. In an embodiment, the electronic camera, for example electronic camera 300 (FIG. 3), is preconfigured to capture a certain number of real-life images, for example 100 or 1000, before performing method 900. Instead of first performing step 910 on all real-life images and then performing step 920 on all real-life images, the real-life images may instead be sequentially processed by steps 910 and 920, without departing from the scope hereof. This may be extended to sequential performance of step 550 (FIG. 5), step 910, and step 920, which allows the electronic camera, e.g., electronic camera 300 of FIG. 3, to continuously evaluate the amount of useable data available for the performance of subsequent steps of method 900. Additionally, sequential capture and processing of images in steps 550 (FIG. 5) and steps 910 and 920 allows for reduced storage requirements. Instead of storing full images, only storage of color values extracted from the images is required for self-training. In an example, electronic camera 300 (FIG. 3), with memory 400 (FIG. 4) implemented as memory 320 (FIG. 3), captures an image in step 550 (FIG. 5). Processor 330 (FIG. 3) performs steps 910 and 920 of this image. If the image is captured under the first illuminant, processor 330 (FIG. 3) determines a color value of the image according to color value extraction instructions 451 (FIG. 4). Processor 330 (FIG. 3) stores the color value to color value storage 462 (FIG. 4).

In an embodiment, the electronic camera, e.g., electronic camera 300 of FIG. 3, is preconfigured to proceed to step 930 upon identification of a certain number of real-life images, for example 50 or 500, in step 920. In certain embodiments, self-training takes place gradually. Step 550 (FIG. 5), steps 910 and 920, and step 560 (FIG. 5) are performed multiple times as the number of images captured by the electronic camera increases. This results in a gradually improving final AWB parameter set as the accuracy of the gray world assumption increases with the number of different scenes imaged by the electronic camera. In further embodiments, self-training, composed of step 550 (FIG. 5), steps 910 and 920, and step 560 (FIG. 5), is repeated regularly throughout the life of the electronic camera.

FIG. 11 illustrates one exemplary method 1100 for performing step 555 of method 500 (FIG. 5). Method 900 is part of the automated self-training based on real-life images and utilizes that all human faces, regardless of race or ethnicity, have essentially the same facial hue. Hue relates to color perception and expresses the degree to which a color is similar to or different from a set of primary colors. Hue may be expressed in terms of primary color components, e.g., R, G, and B, as described by Preucil's equation:

$$Hue ( R , G , B ) = atan ( \frac{\sqrt{3} ( G - B )}{2 R - G - B} ) .$$

Method 1100 is similar to method 900 (FIG. 9), which utilized the gray world assumption, except that method 1100 includes identifying human faces in the real life images, and utilizes the assumption of a universal human facial hue to derive an AWB parameter.

The first two steps of method 1100 are steps 910 and 920 of method 900 (FIG. 9). After performing steps 910 and 920, method 1100 proceeds to a step 1125. Using a face detection algorithm, step 1125 selects a subset of the real-life images, identified in step 920 as being captured under the first illuminant, that further include at least one human face. Step 1125 is, for example, performed by processor 330 of electronic camera 300 (FIG. 3) with memory 400 (FIG. 4) implemented as memory 340 (FIG. 3). Processor 330 (FIG. 3) retrieves the real-life images identified in step 920 from image storage 461 (FIG. 4), and processes the real-life images according to face detection instructions 455 (FIG. 4). Processor 330 (FIG. 3) then saves the real-life images captured under the first illuminant and further including at least one human face, or a record of these images, to image storage 461 (FIG. 4). In a step 1130, the average color of human faces in the real-life images, selected in step 1125, is determined, for example by processor 330 of electronic camera 300 (FIG. 3), with memory 400 (FIG. 4) implemented as memory 340 (FIG. 3), according to color extraction instructions 451.

A step 1140 invokes the universal human facial hue assumption discussed above. For example, the universal human facial hue assumption is invoked by processor 330 of electronic camera 300 (FIG. 3) with memory 400 (FIG. 4) implemented as memory 340 (FIG. 3). Processor 330 (FIG. 3) retrieves universal human facial hue assumption instructions 482 from memory 450. In a step 1150, the camera-specific calibrated AWB parameter for the first illuminant is determined using the universal human facial hue assumption invoked in step 1140. In accordance with the universal human facial hue assumption, the camera-specific calibrated AWB parameter for the first illuminant is set such that, when applied to the real-life images captured under the first illuminant and including at least one human face, yields an average hue of the human faces in the real-life images that is the universal human facial hue. Note that the average hue of the human faces may be extracted from the average color using Preucil's equation discussed above. In certain embodiments, the average color, obtained in step 1130, is expressed in terms of color ratios. For example, the average color ratio is expressed as an ordered pair of color ratios, which defines the relative strength of three primary color components, as discussed in connection with FIG. 2. Next, the camera-specific calibrated AWB parameter may be calculated from the ordered pair of color ratios. Step 1150 is, for example, performed by processor 330 of electronic camera 300 (FIG. 3) with memory 400 (FIG. 4) implemented as memory 340 (FIG. 3). Processor 330 (FIG. 3) retrieves color from color value storage 462 (FIG. 4), derives color ratios according to color ratio calculation instructions 452 (FIG. 4), and stores the color ratios to color ratio storage 463 (FIG. 4). Next, processor 330 (FIG. 3) processes the color ratios stored in color ratio storage 463 (FIG. 4), according to color ratio to AWB parameter calculation instructions 453 (FIG. 4), to produce the camera-specific calibrated AWB parameter for the first illuminant.

Method 1100 describes processing of images in steps 910, 920, and 1125 with all images processed by step 1110, followed by all images processed by step 920, followed by all images processed by step 1125. In an embodiment, the electronic camera, e.g., electronic camera 300 of FIG. 3, is preconfigured to capture a certain number of real-life images, for example 100 or 1000, before performing method 1100. Instead of propagating the full set of real-life images through steps 910, 920, and 1125 as a group, the real-life images may be sequentially processed by two subsequent steps of steps 910, 920, and 1125, or all of steps 910, 920, and 1125, without departing from the scope hereof. This may be extended to sequential performance of step 550 (FIG. 5), step 910, step 920, and step 1125, which allows the electronic camera, e.g., electronic camera 300 of FIG. 3, to continuously evaluate the amount of useable data available for the performance of subsequent steps of method 1100. Additionally, sequential capture and processing of images in steps 550 (FIG. 5) and steps 910, 920, and 1125 allows for reduced storage requirements. Instead of storing full images, only storage of color values extracted from the images is required for self-training. In an example, electronic camera 300 (FIG. 3), with memory 400 (FIG. 4) implemented as memory 320 (FIG. 3), captures an image in step 550 (FIG. 5). Processor 330 (FIG. 3) then performs step 910 and 920 and, if applicable, step 1125 on this image. If the image is captured under the first illuminant and includes at least one human face, processor 330 (FIG. 3) extracts a color value representative of the hue of human faces in the image according to color value extraction instructions 451 (FIG. 4). Processor 330 (FIG. 3) stores this color value to color values 462 (FIG. 4).

In an embodiment, the electronic camera, e.g., electronic camera 300 of FIG. 3, is preconfigured to proceed to step 1130 when a certain number of real-life images, for example 50 or 500, have been identified in step 1125. In certain embodiments, self-training takes place gradually. Step 550 (FIG. 5), steps 910, 920, and 1125, and step 560 (FIG. 5) are performed multiple times as the number of images captured by the electronic camera increases. This may result in a gradually improving final AWB parameter set as the number of different scenes imaged by the electronic camera increases. In further embodiments, self-training, composed of step 550 (FIG. 5), steps 910, 920, and 1125, and step 560 (FIG. 5), is repeated regularly throughout the life of the electronic camera.

In comparison to self-training based on the gray world assumption, self-training based on the universal human facial hue assumption may require a smaller number of real-life images to provide an accurate calibration of the AWB parameter for the first illuminant. The reason is that each individual human face has a hue that is very close to the universal human facial hue, while it likely requires a multitude of real-life images to achieve an average color composition that is gray. On the other hand, the electronic camera, e.g., electronic camera 300 of FIG. 3, may be employed by a user primarily to capture images of real-life scenes that do not include human faces. In certain embodiments, the electronic camera, e.g., electronic camera 300 of FIG. 3, includes both gray world assumption instructions and the universal human facial hue assumption instructions, and will choose either of the two assumptions depending on the types of images captured.

FIG. 12 illustrates one exemplary method 1200 for performing steps 520 and 530 of method 500 (FIG. 5). Method 1200 is an alternative to method 800 of FIG. 8. Method 1200 utilizes the assumption of universal human facial hue to calibrate the AWB parameter for the reference illuminant. In a step 1210, the electronic camera captures images of a set of sample human faces, actual faces or reproductions thereof, illuminated by a reference illuminant. For example, electronic camera 300 of FIG. 3 captures images of a set of sample human faces illuminated by the D65 illuminant. In a step 1220, the color of each image of a sample human face is determined. In one embodiment, functionality onboard the electronic camera performs step 1220. For example, processor 330 of electronic camera 300 (FIG. 3), with memory 400 (FIG. 4) implemented as memory 340 (FIG. 3), processes the captured images according to face detection instructions 455 (FIG. 4) to locate human faces in the images. Processor 330 (FIG. 3) then processes the portions of the images associated with a human face according to color value extraction instructions 451 (FIG. 4). In another embodiment, step 1220 is performed using functionality outside the electronic camera, e.g., electronic camera 300 (FIG. 3), for example equipment at the manufacturing facility. Step 1220 may be performed prior to full assembly of the electronic camera. In a step 1230, the colors obtained in step 1220 are averaged to determine an average color for human faces in the images captured under the reference illuminant. Step 1230 may be performed externally to the electronic camera, e.g., electronic camera 300 (FIG. 3). Alternatively, step 1230 may be performed onboard the electronic camera, for example by processor 330 of electronic camera 300 (FIG. 3) according to instructions 350 (FIG. 3).

The average color obtained in step 1230 may represent a different hue than the universal human facial hue. For example, the hue may be shifted towards red or blue as compared to the human facial hue. In a step 1240, the AWB parameter for the reference illuminant is calibrated such that the calibrated AWB parameter, when applied to the average color determined in step 1230, yields a color representative of the universal human facial hue. In one embodiment, step 1240 is performed onboard the electronic camera. For example, processor 330 of electronic camera 300 (FIG. 3) performs step 1240 according to instructions 350 (FIG. 3). In another embodiment, step 1240 is performed externally to the electronic camera.

Method 1200 describes processing of images in steps 1210 and 1220 with all images processed by step 1210, followed by all images processed by step 1220. Images may instead be sequentially processed by steps 1210 and 1220, without departing from the scope hereof.

Combinations of Features

Features described above as well as those claimed below may be combined in various ways without departing from the scope hereof. For example, it will be appreciated that aspects of one device or method for automated self-training of auto white balance in electronic cameras described herein may incorporate or swap features of another device or method for automated self-training of auto white balance in electronic cameras described herein. The following examples illustrate possible, non-limiting combinations of embodiments described above. It should be clear that many other changes and modifications may be made to the methods and device herein without departing from the spirit and scope of this invention:

(A) A method for calibrating auto white balancing in an electronic camera may include (i) obtaining a plurality of first color values from a respective first plurality of images, of a respective plurality of real-life scenes, captured by the electronic camera under a first illuminant, (ii) invoking an assumption about a true color value of at least portions of the real-life scenes, and (iii) determining, based upon the difference between the true color value and the average of the first color values, a plurality of final auto white balance parameters.

(B) The method denoted as (A), the plurality of final auto white balance parameters may be associated with a respective plurality of illuminants including the first illuminant.

(C) In the methods denoted as (A) and (B), the plurality of final auto white balance parameters may include a final first auto white balance parameter for the first illuminant.

(D) In the methods denoted as (C), the step of determining may include determining, based upon difference between the true color value and the average of the first color values, the final first auto white balance parameter.

(E) The methods denoted as (C) and (D), may further include transforming a plurality of initial auto white balance parameters that includes an initial first auto white balance parameter for the first illuminant, to produce the plurality of final auto white balance parameters, wherein the initial first auto white balance parameter is transformed to the final first auto white balance parameter.

(F) In the methods denoted as (A) through (E), the step of obtaining may include selecting the first plurality of images from a superset of images, captured by the electronic camera of real-life scenes, wherein each image in the first plurality of images being captured by the first illuminant.

(G) In the methods denoted as (A) through (F), each of the first color values may be an average color of the respective image.

(H) In the method denoted as (G), the true color value may be an average color of the plurality of real-life scenes, where the average color is gray.

(I) In the methods denoted as (A) through (F), each of the first plurality of images may include at least one human face, and each of the first color values may define an average hue of the at least one human face.

(J) In the method denoted as (I), the true color value may be an average hue of human faces in the plurality of real-life scenes, wherein the average hue is a universal human facial hue.

(K) In the methods denoted as (I) and (J), the step of obtaining may include selecting the first plurality of images from a superset of images, captured by the electronic camera of real-life scenes, wherein each image in the first plurality of images is captured by the first illuminant and including at least one human face.

(L) In the method denoted as (K), the step of obtaining may further include applying a face detection routine to the superset of images.

(M) In the methods denoted as (E) through (L), each of the first images may have color defined by a first, second, and third primary color, and the step of transforming may be performed in a two-dimensional space spanned by an ordered pair of a first color ratio and a second color ratio, where the first and second color ratios together defining the relative values of the first, second, and third primary colors;

(N) In the method denoted as (M), the step of transforming may include rotating and scaling the initial white balance parameter set within the two-dimensional space.

(O) In the methods denoted as (M) and (N), the ordered pair may be [second primary color/third primary color, second primary color/first primary color], [first primary color*third primary color/second primary color̂2, third primary color/first primary color], [Log(second primary color/third primary color), Log(second primary color/first primary color)], [Log(first primary color*third primary color/second primary color̂2), Log(third primary color/first primary color)], or a derivative thereof.

(P) In the methods denoted as (C) through (O), the plurality of initial auto white balance parameters may include an initial second auto white balance parameter for a second illuminant, and the method may further include determining the plurality of initial auto white balance parameters by (i) obtaining a plurality of base auto white balance parameters including a base second auto white balance parameter for the second illuminant, (ii) calibrating the base second auto white balance parameter to produce a calibrated value thereof, and (iii) transforming the base auto white balance parameter set to produce the initial auto white balance parameter set, wherein the initial second auto white balance parameter is the calibrated value.

(Q) In the method denoted as (P), the step of calibrating may include capturing, by the electronic camera, a second plurality of images of one or more scenes under the second illuminant, such that the calibrated value, when applied to white balance the second plurality of images, yields an average color of the second plurality of images that is gray.

(R) In the method denoted as (P), the step of calibrating may include capturing, by the electronic camera, a second plurality of images of one or more scenes under the second illuminant, wherein each of the one or more scenes comprising a human face, and the calibrated value, when applied to white balance the second plurality of images, yields an average hue of the human faces that is a universal human facial hue.

(S) In the methods denoted as (P) through (R), the plurality of base auto white balance parameters may be determined from images captured by a second electronic camera.

(T) An electronic camera device may include (i) an image sensor for capturing real-life images of real-life scenes, (ii) a non-volatile memory comprising machine-readable instructions, the instructions comprising a partly calibrated auto white balance parameter set and auto white balance self-training instructions, and (iii) a processor for processing the real-life images according to the self-training instructions to produce a fully calibrated auto white balance parameter set, wherein the fully calibrated auto white balance parameter set is specific to the electronic camera.

(U) In the device denoted as (T), the self-training instructions may include an assumption about the real-life scenes.

(V) In the device denoted as (U), the assumption may include an assumption that the average color of a plurality of the real-life scenes is gray.

(W) In the device denoted as (V), the assumption may include an assumption that the hue of human faces is a universal human facial hue.

(X) In the devices denoted as (T) through (W), the self-training instructions may include illumination identification instructions that, when executed by the processor, identifies a subset of the real-life images captured under a first illuminant.

(Y) In the device denoted as (X), auto white balance parameter transformation instructions that, when executed by the processor, transforms a partly calibrated auto white balance parameter set to a fully calibrated auto white balance parameter set based on analysis of the images identified using the illumination identification instructions.

(Z) In the devices denoted as (T) through (Y), the self-training instructions may further include face detection instructions that, when executed by the processor, identifies human faces in real-life images.

Changes may be made in the above methods and devices without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and device, which, as a matter of language, might be said to fall therebetween.

What is claimed is:

1. A method for calibrating auto white balancing in an electronic camera, comprising:
obtaining a plurality of first color values from a respective first plurality of images, of a respective plurality of real-life scenes, captured by the electronic camera under a first illuminant;
invoking an assumption about a true color value of at least portions of the real-life scenes; and
determining, based upon the difference between the true color value and the average of the first color values, a plurality of final auto white balance parameters for a respective plurality of illuminants including the first illuminant.

2. The method of claim 1, the plurality of final auto white balance parameters comprising a final first auto white balance parameter for the first illuminant, and the step of determining comprising
determining, based upon difference between the true color value and the average of the first color values, the final first auto white balance parameter; and
transforming a plurality of initial auto white balance parameters, comprising an initial first auto white balance parameter for the first illuminant, to produce the plurality of final auto white balance parameters, the initial first auto white balance parameter being transformed to the final first auto white balance parameter.

3. The method of claim 1, the step of obtaining comprising selecting the first plurality of images from a superset of images, captured by the electronic camera of real-life scenes, each image in the first plurality of images being captured by the first illuminant.

4. The method of claim 1,
each of the first color values being an average color of the respective image; and
the true color value being an average color of the plurality of real-life scenes, the average color being gray.

5. The method of claim 1,
each of the first plurality of images comprising at least one human face;
each of the first color values defining an average hue of the at least one human face; and
the true color value being an average hue of human faces in the plurality of real-life scenes, the average hue being a universal human facial hue.

6. The method of claim 5, the step of obtaining comprising selecting the first plurality of images from a superset of images, captured by the electronic camera of real-life scenes, each image in the first plurality of images being captured by the first illuminant and including at least one human face.

7. The method of claim 6, the step of obtaining further comprising applying a face detection routine to the superset of images.

8. The method of claim 2,
each of the first images having color defined by a first, second, and third primary color; and
the step of transforming being performed in a two-dimensional space spanned by an ordered pair of a first color ratio and a second color ratio, the first and second color ratios together defining the relative values of the first, second, and third primary colors;

9. The method of claim 8, the step of transforming comprising rotating and scaling the initial white balance parameter set within the two-dimensional space.

10. The method of claim 8, the ordered pair being [second primary color/third primary color, second primary color/first primary color], [first primary color*third primary color/second primary color̂2, third primary color/first primary color], [Log(second primary color/third primary color), Log(second primary color/first primary color)], [Log(first primary color*third primary color/second primary color̂2), Log(third primary color/first primary color)], or a derivative thereof.

11. The method of claim 2, the plurality of initial auto white balance parameters comprising an initial second auto white balance parameter for a second illuminant, the method further comprising determining the plurality of initial auto white balance parameters by:
obtaining a plurality of base auto white balance parameters comprising a base second auto white balance parameter for the second illuminant;
calibrating the base second auto white balance parameter to produce a calibrated value thereof; and
transforming the base auto white balance parameter set to produce the initial auto white balance parameter set, the initial second auto white balance parameter being the calibrated value.

12. The method of claim 11,
the step of calibrating comprising capturing, by the electronic camera, a second plurality of images of one or more scenes under the second illuminant; and
the calibrated value, when applied to white balance the second plurality of images, yielding an average color of the second plurality of images that is gray.

13. The method of claim 11,
the step of calibrating comprising capturing, by the electronic camera, a second plurality of images of one or more scenes under the second illuminant, each of the one or more scenes comprising a human face; and
the calibrated value, when applied to white balance the second plurality of images, yielding an average hue of the human faces that is a universal human facial hue.

14. The method of claim 11, the plurality of base auto white balance parameters being determined from images captured by a second electronic camera.

15. An electronic camera device comprising:
an image sensor for capturing real-life images of real-life scenes;
a non-volatile memory comprising machine-readable instructions, the instructions comprising a partly calibrated auto white balance parameter set and auto white balance self-training instructions; and
a processor for processing the real-life images according to the self-training instructions to produce a fully calibrated auto white balance parameter set, the fully calibrated auto white balance parameter set being specific to the electronic camera.

16. The device of claim 15, the self-training instructions comprising an assumption about the real-life scenes.

17. The device of claim 16, the assumption comprising an assumption that the average color of a plurality of the real-life scenes is gray.

18. The device of claim 16, the assumption comprising an assumption that the hue of human faces is a universal human facial hue.

19. The device of claim 15, the self-training instructions comprising:
illumination identification instructions that, when executed by the processor, identifies a subset of the real-life images captured under a first illuminant; and
auto white balance parameter transformation instructions that, when executed by the processor, transforms a partly calibrated auto white balance parameter set to a fully calibrated auto white balance parameter set based on analysis of the images identified using the illumination identification instructions.

20. The device of claim 19, the self-training instructions further comprising face detection instructions that, when executed by the processor, identifies human faces in real-life images.
